(19) United States
(12) Patent Application Publication
(10) Pub. No.: US 2016/0229677 A1
(43) Pub. Date: Aug. 11, 2016

(54) SOLENOID VALVE FOR A BEVERAGE DISPENSING DEVICE

(71) Applicant: NESTEC S.A., Vevey (CH)

(72) Inventors: Olivier Girault, Vevey (CH); Alexis Reust, Lausanne (CH); Roman Bachtold, Schonholzerswilen (CH)

(21) Appl. No.: 15/023,749

(22) PCT Filed: Sep. 18, 2014
(86) PCT No.: PCT/EP2014/069859

§ 371 Date: Mar. 22, 2016

(30) Foreign Application Priority Data
Sep. 24, 2013 (EP) 13185665.0

(51) Int. Cl. B67D 1/00; B67D 1/10; B67D 1/12

(52) U.S. Cl. CPC B67D 1/0034; B67D 1/1284; B67D 1/0085; B67D 1/10; B67D 2001/0093

(57) ABSTRACT

The present invention presents a solenoid valve (1) having a water inlet (3) and two water outlets (4, 5) arranged within a plane. One of the water outlets (5) can be operated by an actuator to be selectively opened or closed. The present invention further presents a beverage dispensing device (10) with a plurality of the solenoid valves (1). Each solenoid valve 1 introduces water into one of a plurality of mixing chambers (13) of the device (10). The present invention allows for an optimized positioning of the solenoid valves (1)inside the beverage dispensing device (10).

### FIELD OF THE INVENTION

The present invention relates to a solenoid valve for a beverage dispensing device. The present invention further relates to a beverage dispensing device having a plurality of solenoid valves. In particular, each solenoid valve is used in the beverage dispensing device to selectively open or close a water supply path into one of a plurality of mixing units.

### BACKGROUND OF THE INVENTION

From the state of the art a beverage dispensing device for preparing and dispensing a variety of beverages is known. The dispensing device typically comprises several mixing units, wherein each mixing unit usually comprises a dissolution chamber. Each mixing unit is dedicated to the mixing of a particular beverage ingredient with water. For example, one mixing unit is dedicated to mixing instant coffee, another mixing unit is dedicated to mixing milk powder, and a further mixing unit is dedicated to mixing chocolate powder. To this end, each mixing unit is connected to a water supply line and is configured to receive beverage ingredients from a plurality of storing containers. While each mixing unit is normally associated with only one of the storing containers, all mixing units are typically supplied by the same water supply line.

The dedication of one mixing unit to one specific beverage ingredient avoids cross-contamination, for example, in case different beverages are ordered one after the other. Further, the dedicated mixing units can be optimized for dissolution and optionally for frothing of the specific beverage.

Since each mixing unit is connected to the same water supply line, each mixing unit is typically associated with a solenoid valve for selectively delivering water into the associated mixing unit or not. The plurality of solenoid valves are usually connected in series in the water supply line. Therefore, each of the solenoid valves requires a water inlet and two water outlets. One water outlet is for delivering water into the mixing unit, and the other water outlet is for bypassing the mixing unit and delivering water to the following mixing unit (or back to e.g. a water tank for the solenoid valve in the line). Each solenoid valve can be operated such that its water outlet to the mixing unit is either open or closed, depending on whether the mixing unit is to be used to prepare a beverage or not.

FIG. 1 shows a common solenoid valve 20 as typically used in the state of the art. The common solenoid valve 20 includes a water inlet 23 and two water outlets 24 and 25 (the water outlet 24 is behind the body 26 of the solenoid valve 20).

The state of the art solenoid valve provides several drawbacks. For example, the solenoid valve is designed for various uses, and therefore has a design that does not enable an optimized positioning of a plurality of such solenoid valves inside a beverage dispensing device. In particular, once the water inlet and respectively the water outlet of such a solenoid valve is attached to a water supply line and a mixing unit, respectively, the position of the other water outlet of the valve is already determined, and is generally not oriented in direction of the following mixing unit. As a consequence, the water flow in the beverage dispensing device has to be reoriented from one solenoid valve to the other (i.e. from one mixing unit to the other), for example, through flexible pipes. However, the reorientation of the water flow creates water pressure drops, which negatively affect the optimal supply of water into each mixing unit.

It is also possible to orient the state of the art solenoid valves differently inside the dispensing device, in order to avoid a too important change of direction between adjacent mixing units. However, such a difference of orientation can create a difference in the way water is delivered, and can particularly cause congestion inside the dispensing device. This leads to a non-effective operation of the beverage dispensing device, and a non-effective maintenance in case or repair. Further, the beverage dispensing device becomes difficult to clean for the technician who does the maintenance of the machine.

FIGS. 2a and 2b show the state of the art case, for which a plurality of solenoid valves 20 of FIG. 1 are connected in series inside a beverage dispensing device 110. When it is activated each solenoid valve 20 is configured to provide a water flow 250 into one of a plurality of mixing units 113. The three solenoid valves 20 are connected in series by flexible tubes 15. It is made clear that a complicated water flow inside the beverage dispensing device 110 is the result as illustrated in FIG. 2b, which is not optimized and causes pressure drops and increases the risk of congestion.

Another drawback of the state of the art solenoid valves is that a part of the water pipe bringing the water from the water inlet to the water outlet goes through the body 26 of the actuator valve. The section of the water pipe is often reduced in that part of the body and it has been observed that when water is hot scale frequently deposits in this part of the valve.

The present invention has the objective to improve the state of the art, in particular the above-mentioned disadvantages. The present invention has the objective to provide a beverage dispensing device with a plurality of solenoid valves, wherein an optimized positioning of the valves in the device is enabled. Further, the objective of the present invention is to improve the water flow inside of a beverage dispending device such that a water pressure drop and a risk of congestion are minimized.

### SUMMARY OF THE INVENTION

The objects of the present invention are solved by a solenoid valve and by a beverage dispensing device according to the independent claims, respectively. The dependent claims develop further advantages of the present invention.

In particular, the present invention is directed to a solenoid valve for a beverage dispensing device, comprising a valve head being attached to a valve body and comprising a water inlet, a first water outlet and a second water outlet, and the valve body housing an actuator for selectively opening and closing the second water outlet, wherein the water inlet, the first water outlet and the second water outlet of the valve head extend within the same plane.

By arranging the water inlet and both water outlets of the valve head within a common plane, a plurality of such solenoid valves can be positioned in an optimized way in a beverage dispensing device. In particular the solenoid valve of the present invention is advantageous for a beverage dispensing device having a plurality of mixing units and having a single water supply line, which is formed by several solenoid valves connected in series.

Because the water flow inside such a beverage dispensing device can be optimized, water pressure drops can be lessened or avoided, and a risk of congestion can be minimized.

Besides in the solenoid valve of the present invention no water pipe goes through the body of the valve that comprises the actuator and less scale settles in the pipes.

Preferably, the valve head is T-shaped or Y-shaped.

In particular, the in-plane water inlet and the two water outlets define the T-shape or Y-shape of the valve head, respectively. Theses specific shapes are preferable for optimizing the positioning of the valves and the direction of the water flow in the beverage dispensing device.

Preferably, the water inlet corresponds to a first arm of the Y- or T-shaped valve head, the first water outlet corresponds to a second arm of the Y- or T-shaped valve head, and the second water outlet corresponds to a leg of the Y- or T-shaped valve head.

In a beverage dispensing device, the second water outlet of each solenoid valve is preferably directed downwards into one of a plurality of mixing units. Thus, the second water outlet is preferably the leg of the Y- or T-shape. The water inlet and the water outlet are either arranged in parallel (in case of a T-shape), or tilted upwards in respect to the downward facing leg (in case of a Y-shape). Due to the specific design of the valve head, the connection of a plurality of solenoid valves in series can be further optimized.

Preferably, the valve head comprises attachment means for attaching it to the valve body, said attachment means being arranged perpendicular to the plane, in which the water inlet, the first water outlet and the second water outlet of the valve head extend.

It is thus possible to position the solenoid valves in such a manner within the beverage dispensing device that the positions of the valve bodies do not influence negatively the optimized positioning of the valve heads.

Preferably, the solenoid valve is provided with connections for connecting the actuator to a printed circuit board, PCB.

In particular, if a plurality of solenoid valves is connected in series, the solenoid valves can be connected one to the other through their water pipes and simultaneously each of them can be connected by electrically conducting lines on the printed circuit board. An overall optimized positioning of the valves in the device is possible.

Preferably, the water connections extend parallel to the plane defined by the water inlet, the first water outlet and the second water outlet.

In this way, the solenoid valve can be plugged into a PCB, whereby the plane, in which the water inlet and the two water outlets extend, is substantially oriented in parallel to the plane of the PCB. Thus, a very efficient and easy positioning of the solenoid valves is possible.

Preferably, the actuator is configured to selectively open and close the second water outlet in response to a command received via the electrical connections.

The solenoid valve can be controlled via the PCB. In particular, if a plurality of solenoid valves are plugged into a PCB and connected in series, the solenoid valves can be controlled via the PCB, either individually or in combination with another.

The present invention is further directed to a beverage dispensing device comprising a plurality of solenoid valves according to the above description.

The solenoid valves can be arranged in the beverage dispensing device in an optimized manner. The beverage dispensing device therefore exhibits less water pressure drops in its internal water supply line, and shows a lower risk of congestion. Therefore, the beverage dispensing device can be operated more effectively. Also in case of necessary repairs or cleaning, the beverage dispensing device is easier to maintain.

According to a first embodiment, the beverage dispensing device can comprise a water supply, a plurality of containers for storing beverage ingredients, a plurality of mixing units for preparing a beverage by mixing a beverage ingredient with water, wherein each mixing unit is configured to receive water from the water supply and a beverage ingredient from a container, wherein each mixing unit is associated with one of the solenoid valves and each solenoid valve is configured to selectively open or close a water path via its second water outlet into the mixing unit.

The plurality of mixing units allows the beverage dispensing device to prepare several beverages without the risk of internal cross-contamination.

According to a second embodiment the beverage dispensing device can comprise :

a water supply,
a diluent nozzle able to deliver at least one jet of diluent and configured to receive water from the water supply,
a diluent tube able to deliver a free flow of diluent and configured to receive water from the water supply,
wherein each of the diluent nozzle and the diluent tube is associated with one of the solenoid valves and each solenoid valve is configured to selectively open or close a water path via its second water outlet into the diluent nozzle or the diluent tube.

In both embodiments, the solenoid valves are preferably connected in series by water pipes, wherein the water inlet is connected to the first water outlet of the previous solenoid valve, or to the water supply for the first valve, and the first water outlet is connected to the water inlet of the next solenoid valve, or the water supply for the last valve.

Due to the serial connection of the solenoid valves, in the first embodiment each mixing unit can be individually supplied with water. In the same manner in the second embodiment the diluent nozzle and the diluent tube can be individually supplied with water. The solenoid valves can be arranged effectively and in a space saving manner inside the beverage dispensing device.

In this preferred embodiment wherein solenoid valves are connected in serie the water supply preferably comprises:

a water tank,
a pump for pumping water from the water tank and delivering said pumped water to the water inlet of the first solenoid valves in serie, and
a valve connected to the first water outlet of the last solenoid valves in serie and to the water tank.

Preferably, the solenoid valves are arranged in the same orientation.

Preferably, the solenoid valves are aligned with each other.

By orienting at least a plurality of solenoid valves, preferably all solenoid valves, in a likewise manner, e.g. pointing all legs of the Y- or T-shaped valve head downwards, and/or aligning at least a plurality of solenoid valves, preferably all solenoid valves, with each other, e.g. placing all solenoid valves in a row on a PCB, a most effective positioning of the solenoid valves in the beverage dispensing device is achieved.

Preferably, each solenoid valve is plugged onto a printed circuit board, PCB, of the device, and is configured to open and close the water path into the mixing unit in response to a command received via the PCB.

The PCB can be aligned vertically inside of the beverage dispensing device, namely behind the solenoid valves. The solenoid valves then connect each mixing unit or diluent nozzle or diluent tube in an efficient manner. Each mixing unit, diluent nozzle or diluent tube can be individually addressed, i.e. water can be supplied to each mixing unit individually, by controlling the plurality of valves individually or in combination via the PCB.

Preferably, the solenoid valves are connected in series by water pipes, wherein the water inlet is connected to the first water outlet of the previous solenoid valve, or to the water supply for the first valve, and the first water outlet is connected to the water inlet of the next solenoid valve, or the water supply for the last valve.

### BRIEF DESCRIPTION OF THE DRAWINGS

The present invention will now be explained in more detail in respect to the attached drawings.

FIG. 1 shows a solenoid valve according to the state of the art.

FIG. 2a, 2b show a beverage dispensing device according to the state of the art.

FIG. 3 shows a Y-shaped solenoid valve according to the present invention.

FIG. 4 shows a Y-shaped solenoid valve according to the present invention.

FIG. 5 shows a T-shaped solenoid valve according to the present invention.

FIG. 6 shows a beverage dispensing device according to the first embodiment of the present invention.

FIG. 7 shows a plurality of Y-shaped solenoid valves according to the present invention connected in series.

FIG. 8 shows a plurality of T-shaped solenoid valves according to the present invention connected in series.

FIG. 9 shows solenoid valves according to the present invention plugged into a PCB of the beverage dispensing device.

FIGS. 10a and 10b show a beverage dispensing device according to the second embodiment of the present invention.

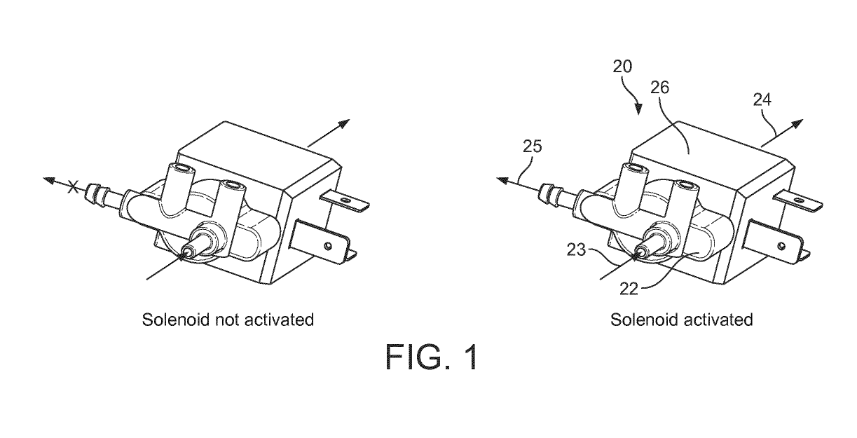

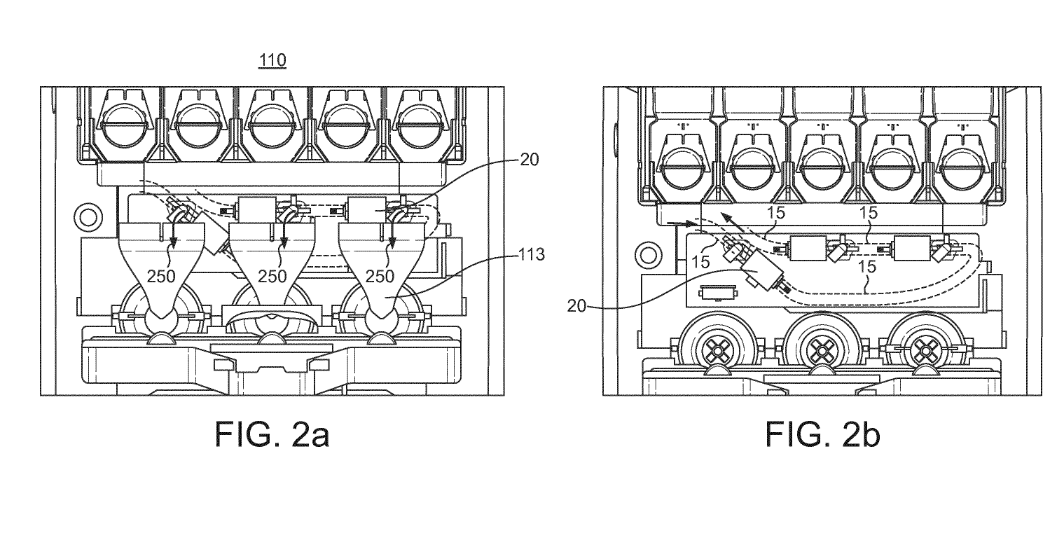

### DETAILED DESCRIPTION OF THE DRAWINGS

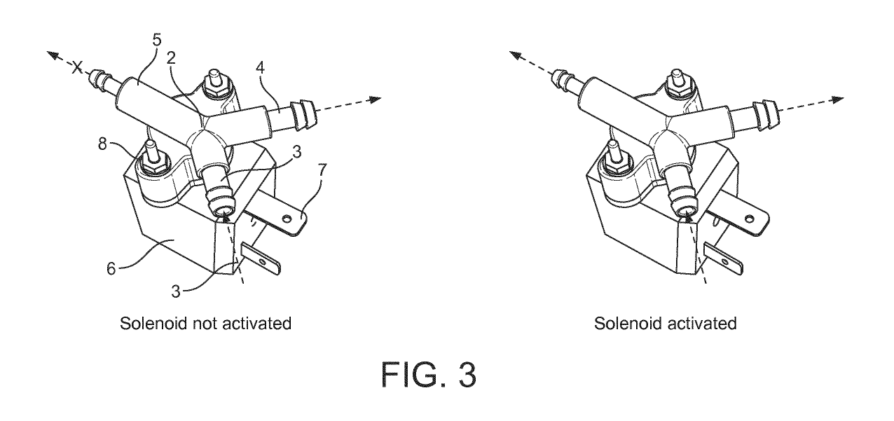

FIG. 3 shows a first embodiment of a solenoid valve 1 of the present invention, namely a Y-shaped solenoid valve 1. The solenoid valve 1 has a valve head 2, which comprises a water inlet 3, a first water outlet 4, and a second water outlet 5. The water inlet 3 and the two water outlets 4, 5 form at least a part of the valve head 2, and are arranged such that they extend within a plane. For example, for the first embodiment extend within a plane forming a Y-shape. The water inlet 3 and the two water outlets 4, 5 are preferably designed as extending tubes for delivering water. The extending tubes are preferably designed such that flexible pipes 15, or the like, can be connected. The extending tubes can, for example, be profiled, in order to allow a more stable attachment of such flexible pipes 15.

The valve head 2 of the solenoid valve 1 is further attached to a valve body 6, for example screwed or glued. The valve body 6 preferably houses an actuator, which is used to operate the solenoid valve 1. In particular, the solenoid valve 1 can be operated so as to selectively open or close its second water outlet 5. FIG. 3 shows on the left side that when the solenoid valve 1 is not activated, the water outlet 5 is closed (as indicated by the crossed out dashed arrow extending from the water outlet 5), i.e. no water can exit the second water outlet 5. If the solenoid valve 1 is activated, the water outlet 5 is opened, and water can exit the second water outlet 5.

The actuator can control the second water outlet 5 electrically or mechanically. Preferably, the actuator in the valve body 6 is itself controlled electrically via connections 7, which extend from the valve body 6. The connections 7 allow the solenoid valve 1, for example, to be plugged into a printed circuit board, PCB 14. Thus, the connections 7 function as mechanical plugs. The connections 7 present also electrical connections between the PCB 14 and the actuator. The actuator is preferably able to receive commands via the connections 7, e.g. commands issued by a control unit of a beverage dispensing device in response to user input.

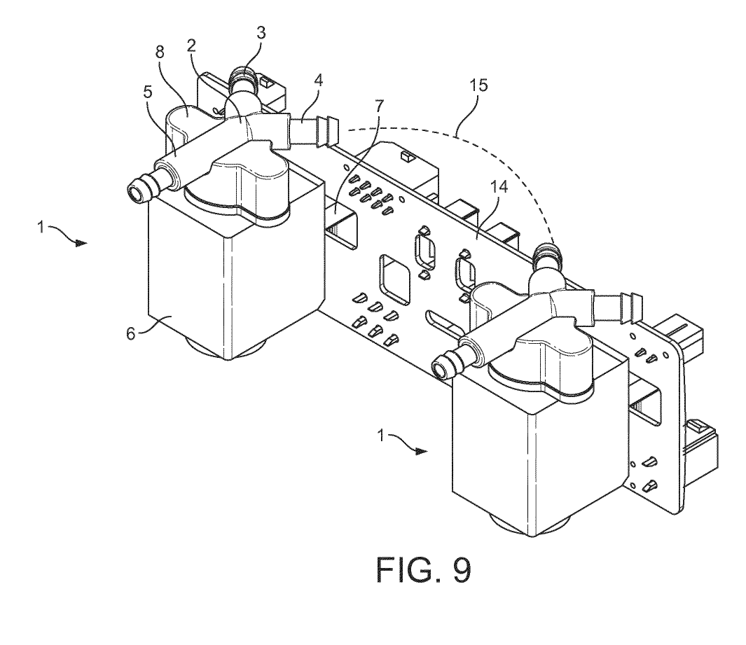

The extension direction of the connections 7 is preferably parallel to the plane, which is defined by the water inlet 3 and the two water outlets 4, 5. The valve body 6, from which the connections 7 extend, is preferably perpendicular to the plane of the water inlet 3 and the two water outlets 4, 5. In this way, the solenoid valve 1 can be plugged into a PCB, for example, as shown in FIG. 9 and explained later in detail.

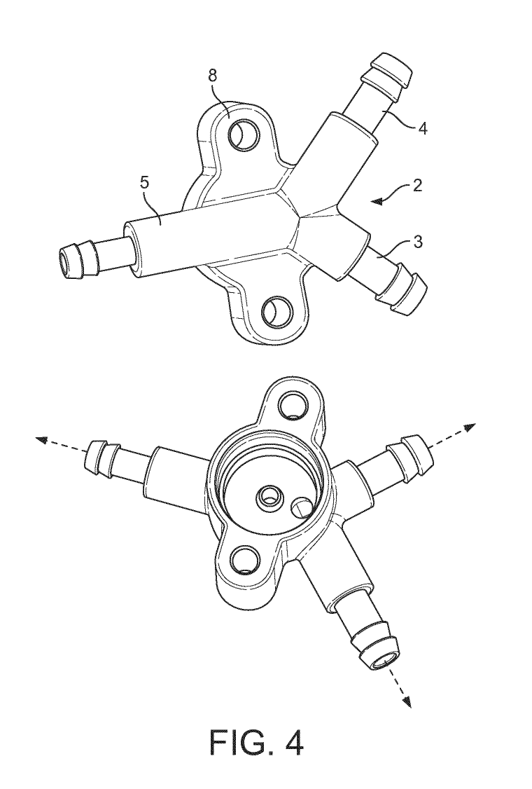

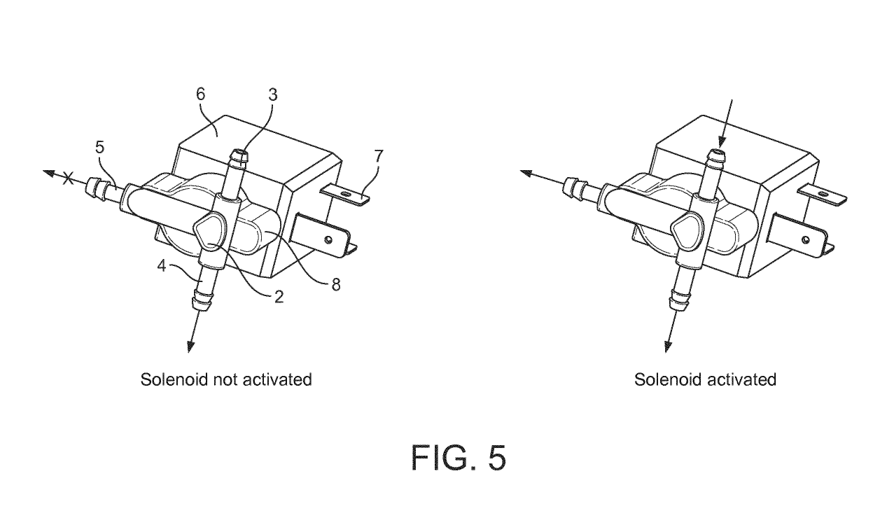

FIG. 4 shows a detailed view of the Y-shaped valve head 2 of the solenoid valve 1. The valve head 2 comprises the water inlet 3 and the two water outlets 4, 5, which are arranged in the same plane, for example to form the Y-shape of the first embodiment. Out of said plane, which is defined by the water inlet 3 and the two water outlets 4, 5, the valve head 2 preferably further comprises attachment means 8 for attaching the valve head 2 to the valve body 6, as shown in FIG. 5. The attachment means 8 are designed, for example, to allow the valve head 2 to be screwed to the valve body 6. However, the attachment means 8 can also be designed to allow gluing or riveting the valve head 2 to the valve body 6.

The whole valve head 2 is preferably manufactured integrally, i.e. from a single piece. For example, the valve head 2 can fabricated by molding, for example, by molding a plastic material. Preferably, at least the Y-shaped (or T-shaped) portion of the valve head 2, which is defined by the water inlet 3 and the two water outlets 4, 5, is designed and fabricated as an integral piece.

FIG. 5 shows another possible design of the solenoid valve 1 of the present invention, in particular a T-shaped solenoid valve 1 as a second embodiment. The T-shaped solenoid valve 1 is designed similar as the Y-shaped solenoid valve 1 of FIG. 3. In particular, a water inlet 3 and two water outlets 4 and 5 extend within a plane. However, this time the water inlet 3 and the first water outlet 4 extend parallel to each other as left and right arms of the T-shape. The second water outlet 5 is the leg of the T-shape, which extends perpendicular to the two arms. FIG. 5 shows that the T-shaped solenoid valve 1 functions just like the Y-shaped solenoid valve 1. In particular, on the left side of FIG. 5 is shown that when the second water outlet 5 is closed, water can only exit the solenoid valve 1 through the first water outlet 4.

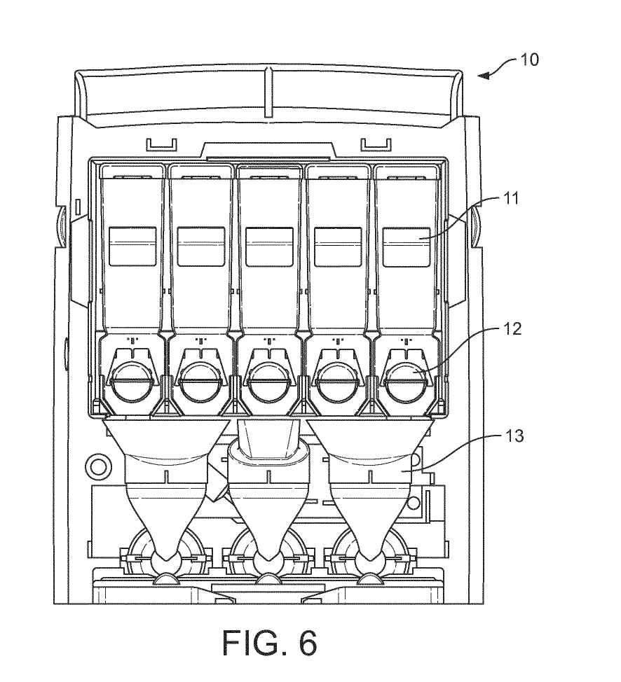

FIG. 6 shows a beverage dispensing device 10 of the present invention. The beverage dispensing device 10 has a plurality of storage containers 11, in which a plurality of different beverage ingredients like coffee, tea, chocolate, milk powder, etc. can be stored. Each of the plurality of storage containers 11 is associated with one beverage ingredient dosing unit 12, which is configured to receive a beverage ingredient from the storage container 11 it is associated with, and provide one dose thereof to its associated mixing unit 13. This means that each mixing unit 13 is associated with at least one, preferably one, beverage ingredient dosing unit 12 and one storage container 11. Thereby, cross-contamination during the preparation of different beverages inside the beverage dispensing device is reduced drastically. Each of the mixing units 13 of the beverage dispensing device 10 is further provided with one solenoid valve 1 as described above.

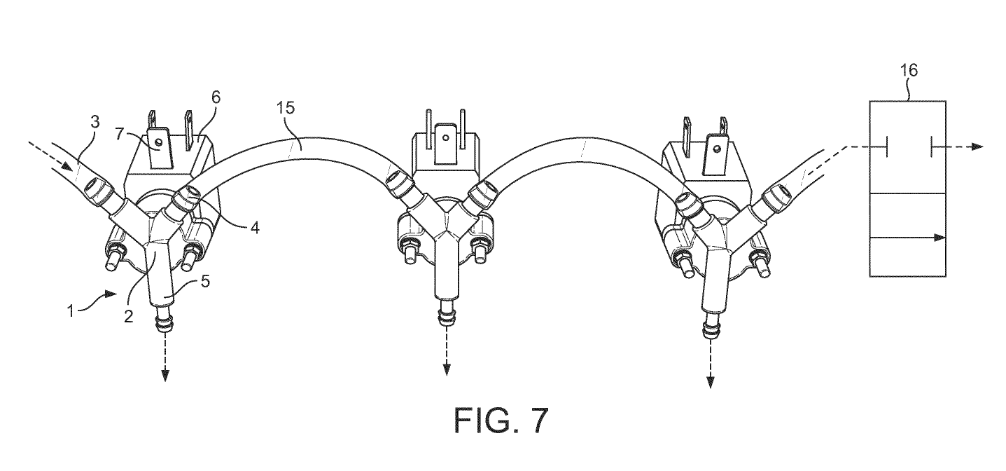

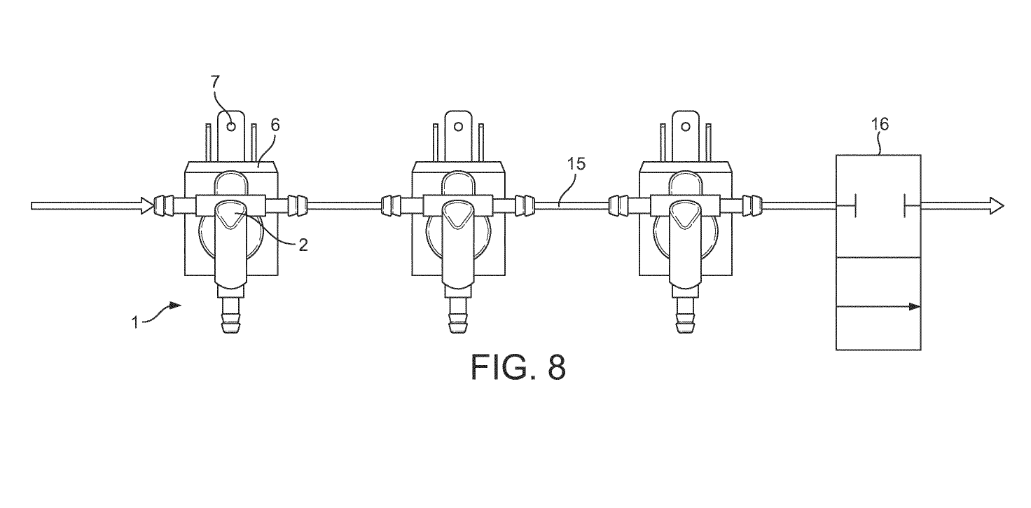

In particular, the solenoid valves 1 are preferably arranged within the beverage dispensing device 10 as shown in the FIGS. 7 an 8, respectively. The FIGS. 7 and 8 show three Y-shaped solenoid valves 1 and three T-shaped solenoid valves 1, respectively, which are connected in series. The solenoid valves 1 are preferably connected together via flexible pipes 15. However, the solenoid valves 1 can also be connected together by other means suitable to transport water from one valve 1 to the other. As can be seen in the FIGS. 7 and 8, if a plurality of solenoid valves 1 are connected in series by water pipes 15, and are preferably aligned and/or oriented in a similar manner, the extension direction of the water inlet 3 and the two water outlets 4, 5 in the same plane allows for a efficient and optimized orientation of the valves 1.

The second water outlet 5 of each solenoid valve 1 is the water outlet for supplying water to an associated mixing unit 13 in the beverage dispensing device 10, since it can be controlled by the actuator. Each of the second water outlets 5 is preferably directed downwards into the associated mixing unit 13. Thus, the solenoid valves 1 are preferably oriented likewise. The second water outlets 5 can further be provided with means for forming a water jet exiting the solenoid valve 1 and being delivered into the mixing units 13.

The first water outlet 4 of each solenoid valve 1 is always set to bypass, that means it is always open. The first water outlet 4 is used in the beverage dispensing device 10 to bypass water received from a common water supply line from one mixing unit 13 to the other.

The first solenoid valve 1 in the series of solenoid valves 1 is connected with its water inlet 3 to a water supply, for example a water tank or a boiler, of the beverage dispensing device 10. The first water outlet 4 of said valve 1 is connected with the water inlet 3 of the next solenoid valve 1 in the line. The second solenoid valve 1 in the line is connected with its first water outlet 4 to the water inlet 3 of the third solenoid valve 1. This means that the water inlet 3 of the solenoid valves is connected to the first water outlet 4 of the previous solenoid valve 1 or to the water supply for the first valve 1. Likewise, the first water outlet 4 is connected to the water inlet 3 of the next solenoid valve 1 or to the water supply for the last valve 1. Thus a water circulation from the water supply of the beverage dispensing device 10, through the series of solenoid valves 1, and back to the water supply is achieved.

As shown further in the FIGS. 7 and 8, between the water outlet 4 of the last valve 1 in the line and the water supply preferably a standard 2/2 valve 16 is arranged, which is normally closed, and controls the water circulation through the water supply line. This standard 2/2 valve can be a simple check valve too that opens only if a specific pressure is reached. Then if the water pressure is inferior to said specific pressure, water flows through a water outlet 5 that is opened in one of the solenoid valves 13. If all water outlets 5 of the three solenoid valves 1 are closed, water pressure can increase upstream to the check valve and said valve can open when the specific pressure is reached. Water can be redirected to the water tank from which water has been pumped. Usually check valve can be used when the pressure of water in the water lines remains low (e.g. less than 1.8 bar) and standard 2/2 valve can be used when the pressure of water in the water lines is higher (e.g. more than 2 bars).

FIG. 9 shows how the solenoid valves 1 of the present invention are plugged into a PCB 14. The PCB 14 can be provided with electrical connections, which connect each solenoid valve 1. Thereby, in particular each actuator housed in a valve body 6 of a solenoid valve 1 is connected, for example, with a control unit of the beverage dispensing device 10. The control unit 10 is preferably adapted to control each solenoid valve 1 in a way so that the second water outlet 5 of each solenoid valve 1 can be selectively opened or closed. The plurality of solenoid valves 1 are arranged in series with each other, and are connected electrically by the PCB 14 in terms of water flow, e.g. by the pipes 15. The way the solenoid valves 1 are designed allows an efficient positioning of the solenoid valves 1 in the beverage dispensing device 10. Preferably, the solenoid valves 1 are oriented likewise so as to provide a very efficient connection. Internal water pipes 15 can be minimized in length, and an internal reorientation of the water flow can be largely avoided.

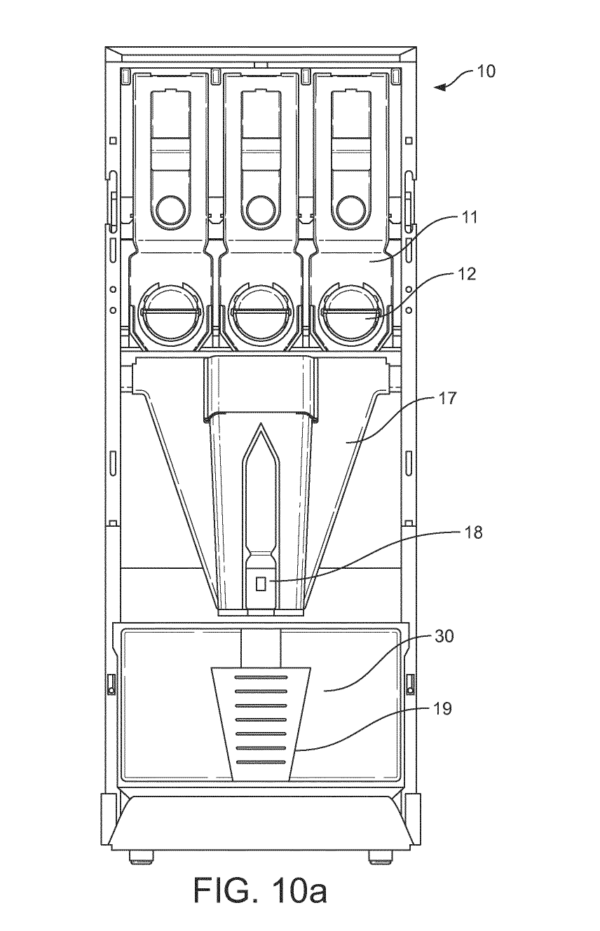

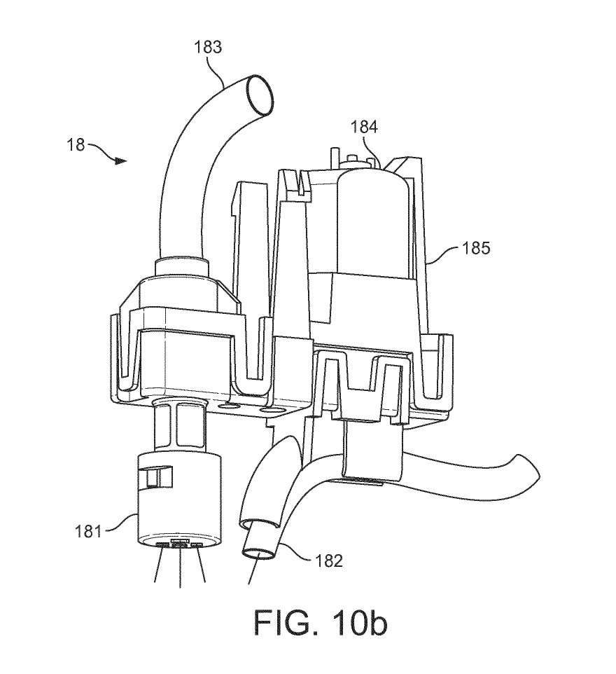

FIG. 10a illustrates a beverage dispensing device 10 of the present invention according to the second embodiment. The beverage dispensing device 10 has a plurality of storage containers 11, in which a plurality of different beverage ingredients like coffee, tea, chocolate, milk powder, etc. can be stored. Each of the plurality of storage containers 11 is associated with one beverage ingredient chute 17, which is configured to receive a beverage ingredient from the storage container 11 it is associated with, and provide one dose thereof to a receptacle placed in the dispensing area 18. This means that the chute device 17 is internally divided in three channels each of them cooperating with one storage container to deliver a beverage ingredient dose to the receptacle 30 placed in the dispensing area 18. The beverage dispensing device 10 also comprises means 18 for supplying water to the receptacle in order to dissolve the beverage ingredient and produce a beverage. This means for supplying water are illustrated in FIG. 10b and comprises:

a diluent nozzle 181 able to deliver at least one jet of diluent, and
a diluent tube 182 able to deliver a free flow of diluent and configured to receive water from the water supply.

Depending on the beverage that is prepared the diluent means can deliver either jet(s) of water to froth the beverage or a free flow of water to avoid froth or to rapidly fill the receptacle. Preferably the jet(s) of water can be rotated to improve mixing and frothing. Such a means for supplying water is particularly described in WO2012/163727. The diluent nozzle 181 can be rotated by a motor 184. The whole assembly of the diluent nozzle 181, its motor 184 and the diluent tube 182 can be fixed by means of support 185. The diluent tube 182 can be a simple flexible tube of which end can be directly plugged to its cooperating solenoid valve. The diluent nozzle 181 can be supplied by a flexible tube 183 that can be directly plugged to its cooperating solenoid valve.

Consequently each of the diluent nozzle 181 and the diluent tube 182 provided with a flexible tube is connected to one solenoid valve 1 as described above, for example the two solenoid valves such as illustrated in FIG. 9.

Due to the fact that the water supply means of the beverage dispenser according to this second embodiment is particularly sensible to any drop of water pressure in the water pipes, the use of the solenoid valve of the present invention in association with said beverage dispenser is advantageous. Actually any loss of water pressure inside the diluent nozzle does not lead to an efficient preparation of the beverage.

According to a particular mode of this second embodiment a standard 2/2 valve can be implemented to create a closed loop in the water supply means such as described hereabove.

In summary, the present invention discloses a solenoid valve 1 and a beverage dispensing device 10 equipped with a plurality of such solenoid valves 1, allowing an optimized positioning of the solenoid valves 1 inside the device 10. As a consequence, in comparison with the state of the art, the water supply inside the device has to be reoriented only very little (or not at all) from one solenoid valve 1 to the other. Therefore, water pressure drops inside the beverage dispensing device 10 are largely reduced. The beverage dispensing device 10 therefore operates more effectively, and has less risk of congestion. Further, the solenoid valves 1 are arranged in a manner within the beverage dispensing device 10 that allows for a more effective maintenance in case of repair or cleaning.

1. Solenoid valve for a beverage dispensing device, comprising:
a valve head being attached to a valve body and comprising a water inlet, a first water outlet and a second water outlet; and
the valve body housing an actuator for selectively opening and closing the second water outlet; and,
the water inlet, the first water outlet and the second water outlet of the valve head extend within the same plane.

2. Solenoid valve according to claim 1, wherein the valve head is T-shaped or Y-shaped.

3. Solenoid valve according to claim 2, wherein
the water inlet corresponds to a first arm of the Y- or T-shaped valve head;
the first water outlet corresponds to a second arm of the Y- or T-shaped valve head; and
the second water outlet corresponds to a leg of the Y- or T-shaped valve head.

4. Solenoid valve according to claim 1, wherein the valve head comprises an attachment member for attaching the valve head to the valve body, the attachment member being arranged perpendicular to the plane, in which the water inlet, the first water outlet and the second water outlet of the valve head extend.

5. Solenoid valve according to claim 1 comprising connections for connecting the actuator to a printed circuit board.

6. Solenoid valve according to claim 5, wherein the connections extend parallel to the plane defined by the water inlet, the first water outlet and the second water outlet.

7. Solenoid valve according to claim 5, wherein the actuator is configured to selectively open and close the second water outlet in response to a command received via the connections.

8. Beverage dispensing device, comprising a plurality of solenoid valves comprising:
a valve head attached to a valve body and comprising a water inlet, a first water outlet and a second water outlet;
the valve body housing an actuator for selectively opening and closing the second water outlet; and
the water inlet, the first water outlet and the second water outlet of the valve head extend within the same plane.

9. Beverage dispensing device according to claim 8, comprising:
a water supply;
a plurality of containers for storing beverage ingredients;
a plurality of mixing units for preparing a beverage by mixing a beverage ingredient with water, wherein each mixing unit is configured to receive water from the water supply and a beverage ingredient from a container; and
each mixing unit is associated with one of the solenoid valves and each solenoid valve is configured to selectively open or close a water path via its second water outlet into the mixing unit.

10. Beverage dispensing device according to claim 8, comprising:
a water supply;
a plurality of containers for storing beverage ingredients;
a diluent nozzle able to deliver at least one jet of diluent and configured to receive water from the water supply;
a diluent tube able to deliver a free flow of diluent and configured to receive water from the water supply; and
each of the diluent nozzle and the diluent tube is associated with one of the solenoid valves and each solenoid valve is configured to selectively open or close a water path via its second water outlet into the diluent nozzle or the diluent tube.

11. Beverage dispensing device according to claim 9, wherein:
the solenoid valves are connected in series by water pipes;
the water inlet is connected to the first water outlet of the previous solenoid valve, or to the water supply for the first valve; and
the first water outlet is connected to the water inlet of the next solenoid valve, or the water supply for the last valve.

12. Beverage dispensing device according to claim 11, wherein the water supply comprises:
a water tank;
a pump for pumping water from the water tank and delivering said pumped water to the water inlet of the first solenoid valves in series; and
a valve connected to the first water outlet of the last solenoid valves in serie and to the water tank.

13. Beverage dispensing device according to claim 9, wherein the solenoid valves are arranged in the same orientation.

14. Beverage dispensing device according to claim 9, wherein each solenoid valve is plugged onto a printed circuit board of the device, and is configured to open and close the water path into the mixing unit in response to a command received via the printed circuit board.

15. Beverage dispensing device according to claim 9, further comprising a plurality of beverage ingredient dosing units each configured to receiving a beverage ingredient from a container and to deliver a predetermined dose of the received beverage ingredient to a mixing unit or to a receptacle.
